(19) United States
(12) Patent Application Publication
(10) Pub. No.: US 2006/0093298 A1
(43) Pub. Date: May 4, 2006

(54) Integrated optical waveguide and process for fabrication

(76) Inventors: Pietro Montanini, Milano (IT); Ernestino Galeazzi, Corbetta (IT); Paola Palmieri, Bollate (IT)

Correspondence Address: HOGAN & HARTSON LLP, ONE TABOR CENTER, SUITE 1500, 1200 SEVENTEENTH ST, DENVER, CO, 80202, US

(21) Appl. No.: 11/258,362

(22) Filed: Oct. 25, 2005

(30) Foreign Application Priority Data
Nov. 4, 2004 (IT) RM2004A000544

(51) Int. Cl. G02B 6/10

(52) U.S. Cl. 385/129

(57) ABSTRACT

A waveguide core having a high coupling efficiency is disclosed. A method of manufacturing such a waveguide includes successive deposition of multiple layers of silicon dioxide. Deposition of each layer is followed by implantation of dopant impurities in a pre-established area of the layer. After deposition and implantation, high-temperature treatment is performed to diffuse the dopant impurities. The reciprocal position of the pre-established areas and the implantation dosage and energy are selected such that the refractive index of the core in the terminal segment varies gradually in a longitudinal direction, increasing towards the input/output ends of the waveguide.

### RELATED APPLICATION

The present application claims priority of Italian Patent Application No. RM2004A000544 filed Nov. 4, 2005, entitled INTEGRATED OPTICAL WAVEGUIDE AND PROCESS FOR ITS FABRICATION, which is incorporated herein in its entirety by this reference.

### FIELD OF THE INVENTION

The present invention relates to the field of optical waveguides and more particularly to an integrated optical waveguide and process for its fabrication.

### BACKGROUND OF THE INVENTION

In the field of telecommunications and data transmission, the current tendency to use optical signals instead of traditional electrical signals is well known. Transmission of optical signals takes place by means of optical waveguides and generation and processing of the optical signals takes place by means of optical devices, such as laser sources, amplifiers, modulators, and the like. Many of these devices can be produced in the form of integrated planar optical circuits using manufacturing techniques typical of integrated planar semiconductor electronic circuits. According to one of said techniques the waveguides are formed, together with other optical components, on a silicon substrate or on a dielectric substrate. First, a layer of silicon dioxide with a relatively low refractive index (e.g. 1.458) is deposited on the substrate, intended to make up the lower cladding of the cores of the waveguides; then another layer of silicon dioxide with a relatively high refractive index (n_{c}>1,46) is deposited on the lower cladding; the cores of the waveguides are obtained from this layer by means of selective anisotropic etching using normal photolithographic techniques; finally, a further layer of silicon dioxide is deposited, usually with the same refractive index as the lower cladding, in order to cover both the sides and top of the cores. With this technique it is possible to obtain waveguides with a substantially square cross-section.

One important aspect in designing optical systems is the coupling of different devices both inside and outside the same integrated optical circuit, for example coupling between an integrated waveguide and an optic fiber. The ends of the waveguides to be coupled together may have very different cross-sections. For example, the input waveguide of a device to be interfaced with a laser source may have one end with a square section with sides of 5 μm while the laser source emits a luminous power from a circular or elliptical cross-section with axes between 0.5 μm and 2 μm in a solid angle with openings between 20 and 40 degrees on both axes, or the output waveguide of a device to be interfaced with an optic fiber may have one end with a square cross-section with sides of 5 μm and the input end of the optic fiber may have a circular cross-section with a 9 μm diameter. In these conditions, the efficiency of the coupling is generally very low.

In order to obtain more efficient couplings, various techniques are known: some of these require interposition of optical systems between the waveguides to be coupled, others envisage modifications to the terminal segments of either one or the other or both the waveguides to be coupled, gradually increasing or reducing the cross-section adiabatically, i.e. substantially without loss and maintaining the single-mode transmission characteristics of the guide. These techniques, however, are rather complex and, since they require an increase in the cross-sections of the input and output ends of the waveguides, they are not suitable to be used in integrated optical circuits with multiple input/output ports.

### SUMMARY OF THE INVENTION

Another approach to increase the efficiency of the coupling between waveguides having different cross-sections comprises increasing the refractive index of the core of the waveguide with the smaller cross-section. In this way, the effective area of the end of the waveguide with the smaller cross-section is increased but immunity to noise of the entire waveguide is reduced.

The present invention provides a waveguide and a process for its fabrication that permits high waveguide coupling efficiency without foregoing the most convenient index contrast for most of its length.

The integrated optical waveguide of the present invention is defined by a core and cladding and includes a terminal segment having an input/output end. The core has a refractive index in the terminal segment that varies gradually in a longitudinal direction and increases towards the input/output end.

In a preferred process for fabricating an integrated optical waveguide on a substrate, a layer of a material for the lower cladding of the waveguide is deposited on the substrate. Material for the waveguide core is deposited on the lower cladding material. The waveguide core material is selectively removed to form the waveguide core and define an input/output end of the waveguide. Upper cladding material is deposited to cover the top and sides of the waveguide core such that the operation to deposit a layer for the core includes the successive deposition of multiple layers of a material with a pre-established refractive index, with deposition of each layer followed by implantation of dopant impurities (P+) in a pre-established area of the respective layer so as to modify the pre-established refractive index. The method includes a high-temperature treatment to diffuse the dopant impurities. The reciprocal position of the pre-established areas of the various layers and the implantation dosages and energy are selected such that after the high-temperature treatment, the refractive index of the core in a segment of the waveguide that terminates in an input/output end, varies gradually in a longitudinal direction and increases towards the input/output end of the waveguide.

### BRIEF DESCRIPTION OF THE DRAWINGS

The invention will become more apparent from the following detailed description of an embodiment thereof as illustrated in the accompanying drawings, in which the various figures represent a terminal segment of a waveguide according to the invention in various steps of the fabrication process, and more particularly:

FIGS. 1a to 12a illustrate lateral cross-sections of a preferred embodiment of the present invention; and

FIGS. 1b to 12b illustrate longitudinal cross-sections of the invention shown in FIGS. 1a to 12a.

### DETAILED DESCRIPTION

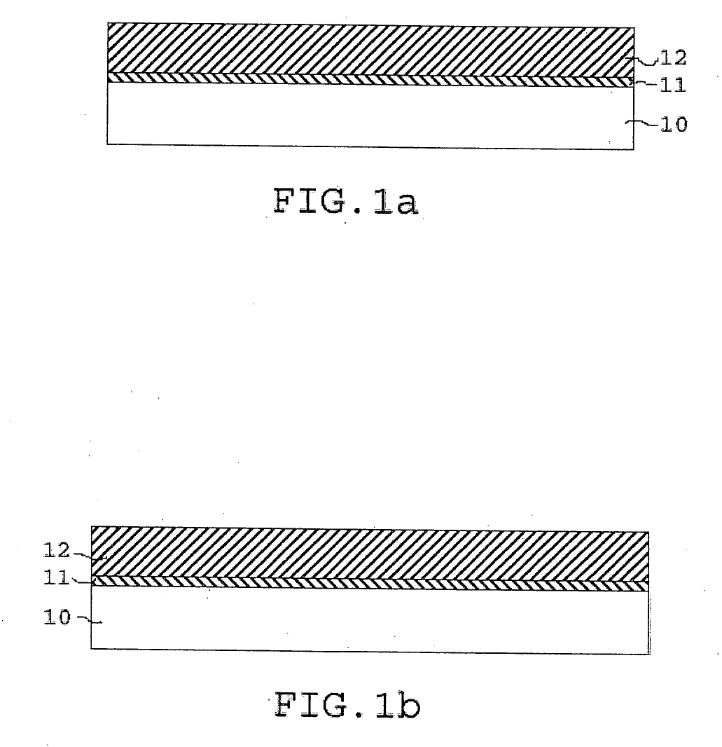

With reference to the drawings, in particular FIGS. 1a and 1b, in order to form an integrated planar optical device, a single crystal silicon substrate 10 is subjected to oxidation at high temperature so as to form a layer of silicon dioxide 11 on one of its surfaces. The purpose of said layer, which is relatively thin, is to ensure interfacing with a subsequent layer 12, which is relatively thick, of silicon dioxide obtained by vapor-phase deposition. The layer 12 has a pre-established refractive index and is intended to comprise the lower cladding layer of the waveguides of the optical circuit.

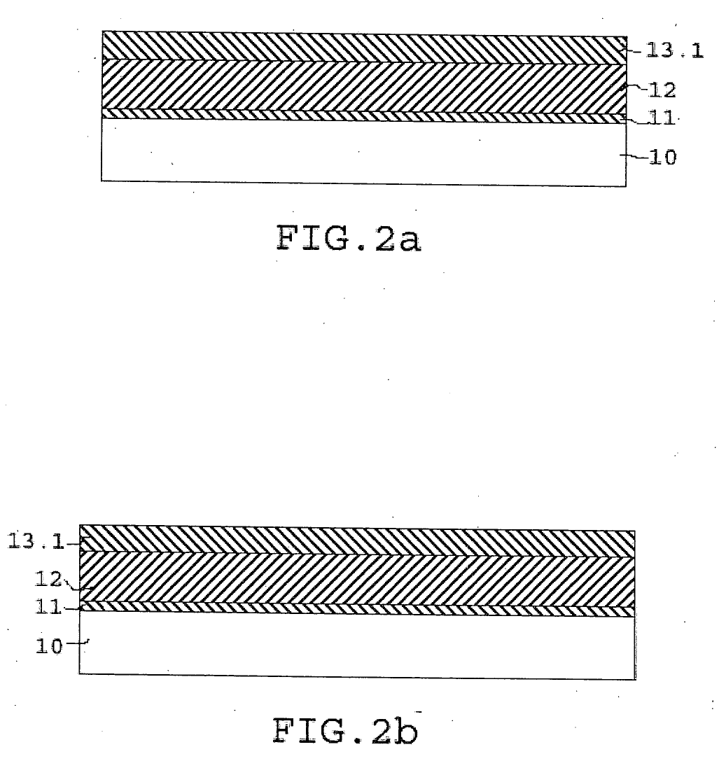

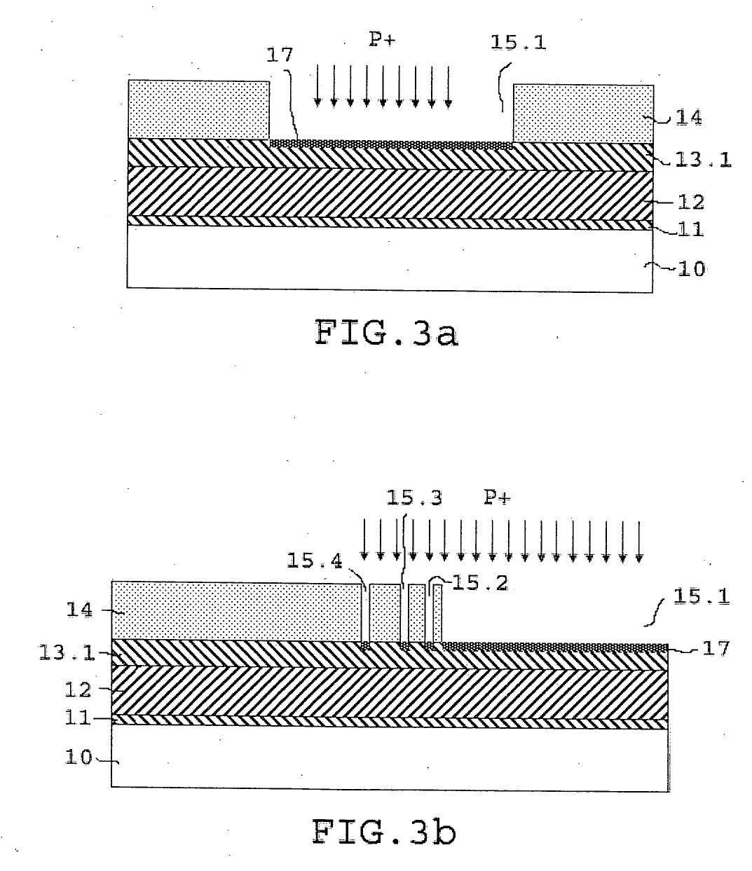

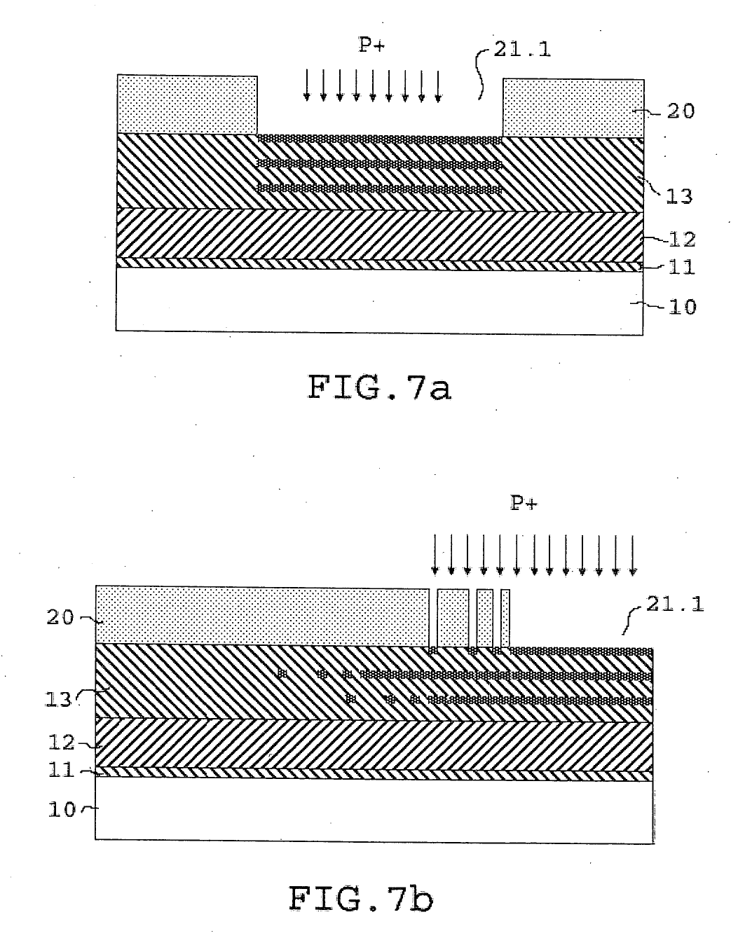

A multi-layer 13 (FIGS. 7a and 7b) of silicon dioxide, from which the waveguide cores will be obtained, is formed on the layer 12. In this example, the multi-layer is made up of three layers with the same refractive index and formed through vapor-phase deposition. The number of layers can be more than three, the refractive indexes can be different from each other and their formation process can be different from vapor-phase deposition. In particular, a first layer 13.1 (FIGS. 2a and 2b) is deposited and a photoresist mask 14 is formed thereon (FIGS. 3a and 3b), with openings on to areas intended to contain the terminal segments of the waveguides. In the illustrated embodiment, the mask 14 has, for every terminal segment of the waveguide to be treated, a main opening 15.1 and further openings. Three are shown in this embodiment indicated 15.2, 15.3 and 15.4, which leave other areas near one edge of the main area 15.1 exposed. The mask 14 enables selective implantation in the layer 13.1 of dopant impurities to modify its refractive index. Implantation, carried out for example with a dosage of 5e17 of phosphorus ions (P+) with an energy of 50 keV, is represented by arrows in the drawing and the enrichment due to implantation is represented by thin superficial regions 17.

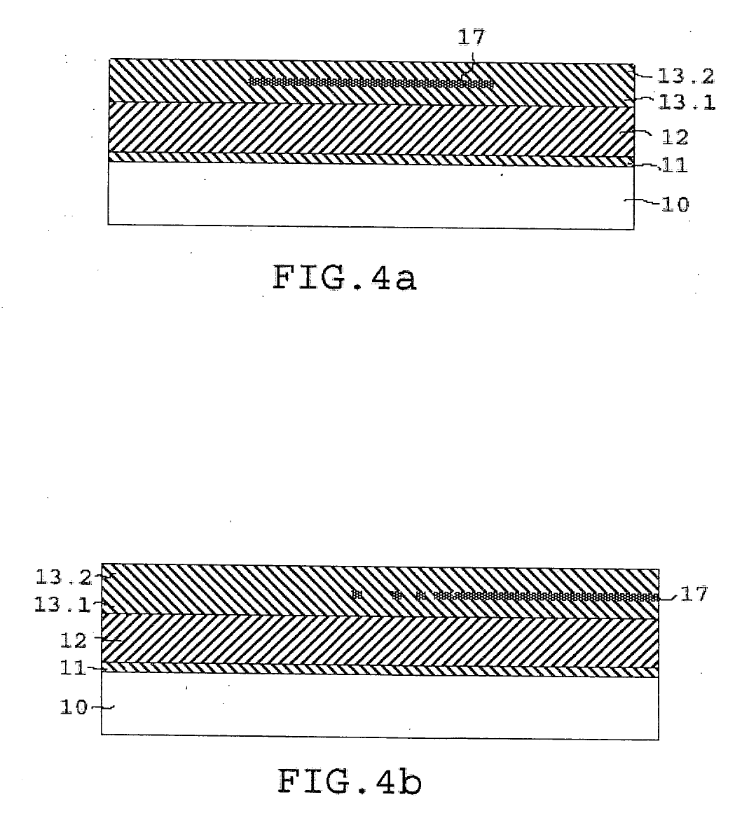

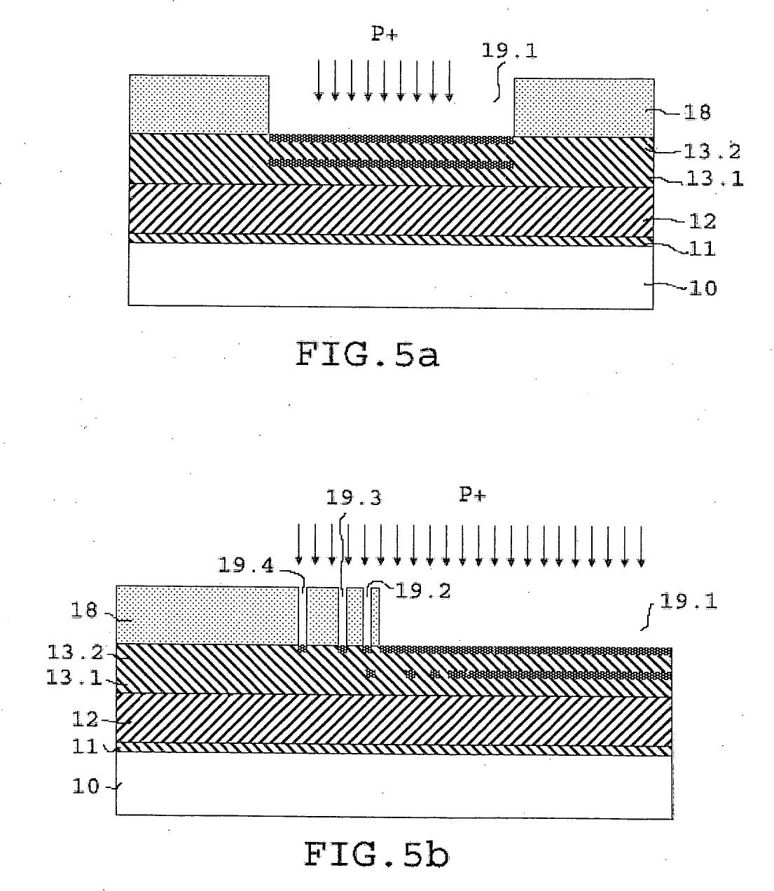

The mask 14 is then removed and a second layer 13.2 of silicon dioxide is deposited (FIGS. 4a and 4b). A second photoresist mask 18 is formed (FIGS. 5a and 5b) similar to the mask 14 and further selective implantation is carried out, for example again with phosphorus ions (P+), with a dosage of 1e18 and an energy of 30 keV, on the areas intended to contain the terminal segments of the waveguides. For every terminal segment, the main opening of the mask, indicated with 19.1, is wider than the main opening 14.1 of the previous mask, i.e. one part is exposed that is longer than the terminal segment, as can be seen in detail in the longitudinal section in FIG. 5b.

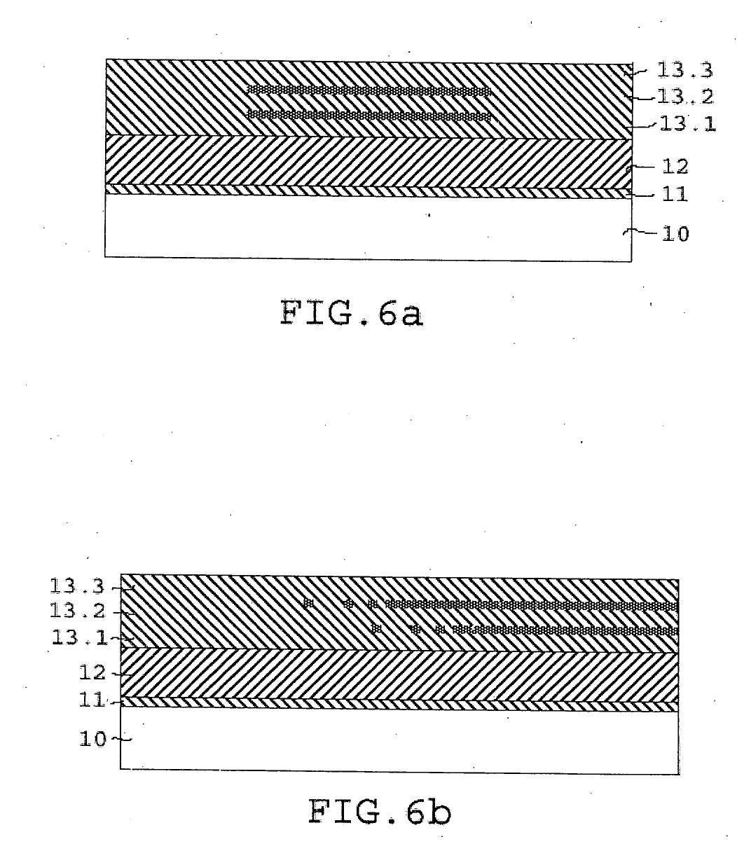

The mask 18 is then removed, and a third layer 13.3 of silicon dioxide is deposited (FIGS. 6a and 6b), a third photoresist mask 20 is formed and a third selective implantation is carried out (FIGS. 7a and 7b). For example, the implantation can be performed again with phosphorus ions, with a dosage of 5e17 and an energy of 50 keV. The main opening of the mask, indicated with 21.1, is again different, for example it is shorter than the main openings of the two previous masks, i.e. one part is exposed that is shorter then the terminal segment of the waveguide, as can be seen in FIG. 7b.

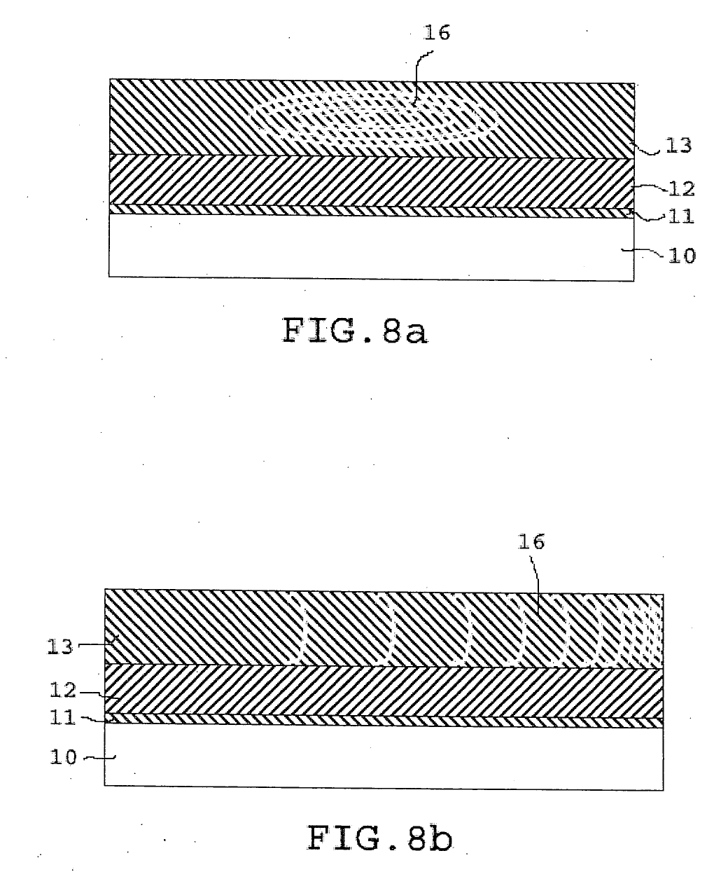

Once the deposition and implantation operations have been terminated, high-temperature treatment (annealing) is carried out, during which the implanted impurities spread inside the multi-layer 13, creating a region 16 where, as illustrated in FIGS. 8a and 8b. The density of the dopant impurities varies gradually both longitudinally, increasing from left to right looking at the drawing, and transversally.

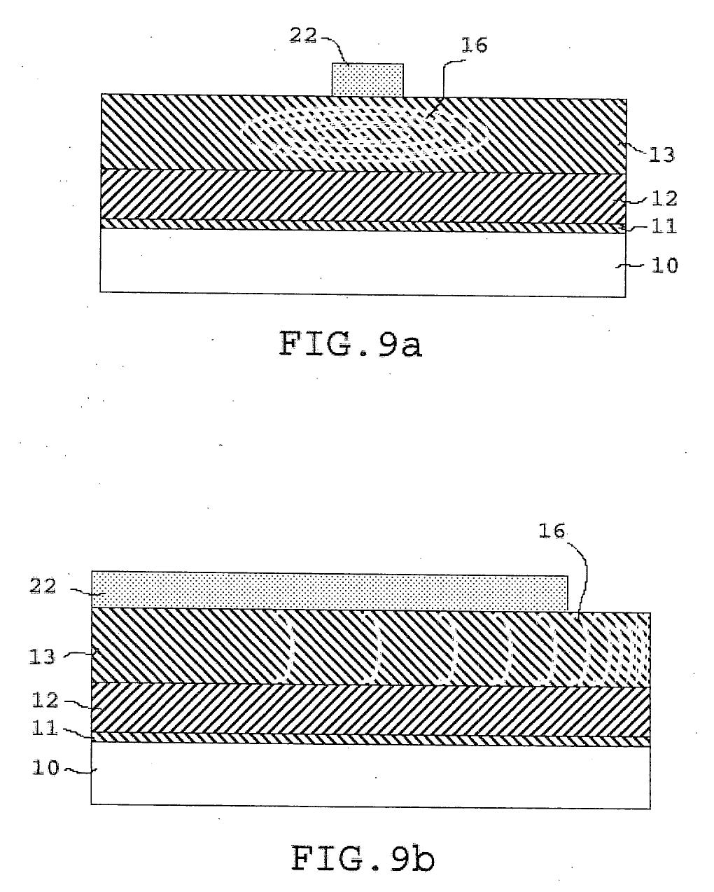

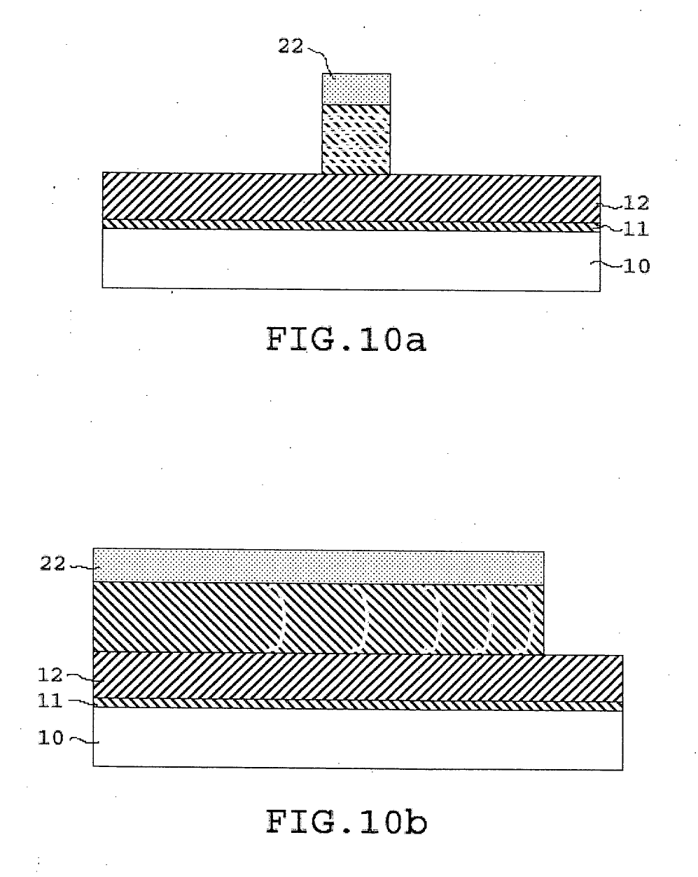

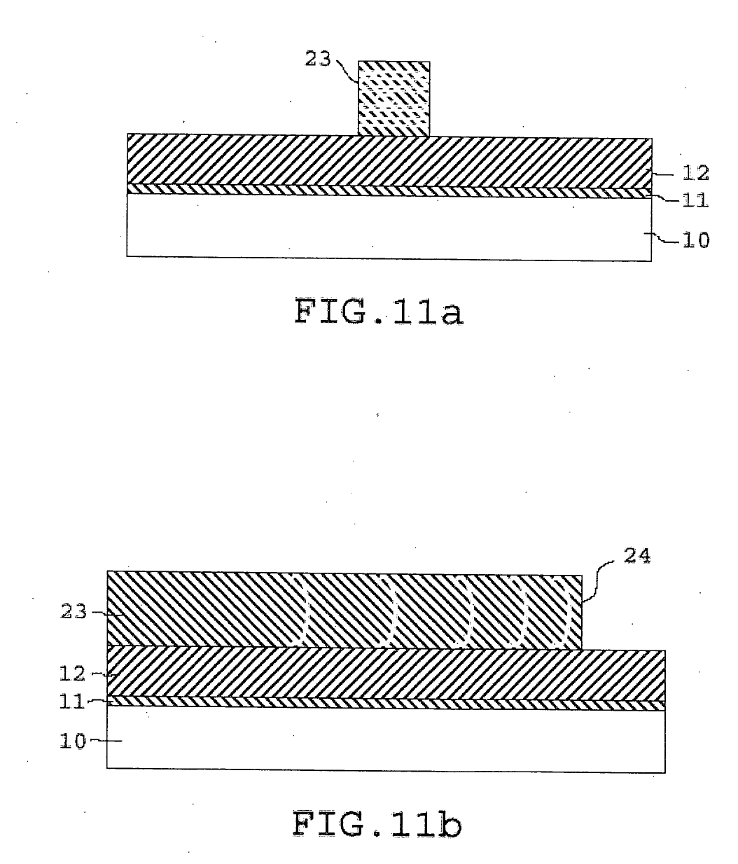

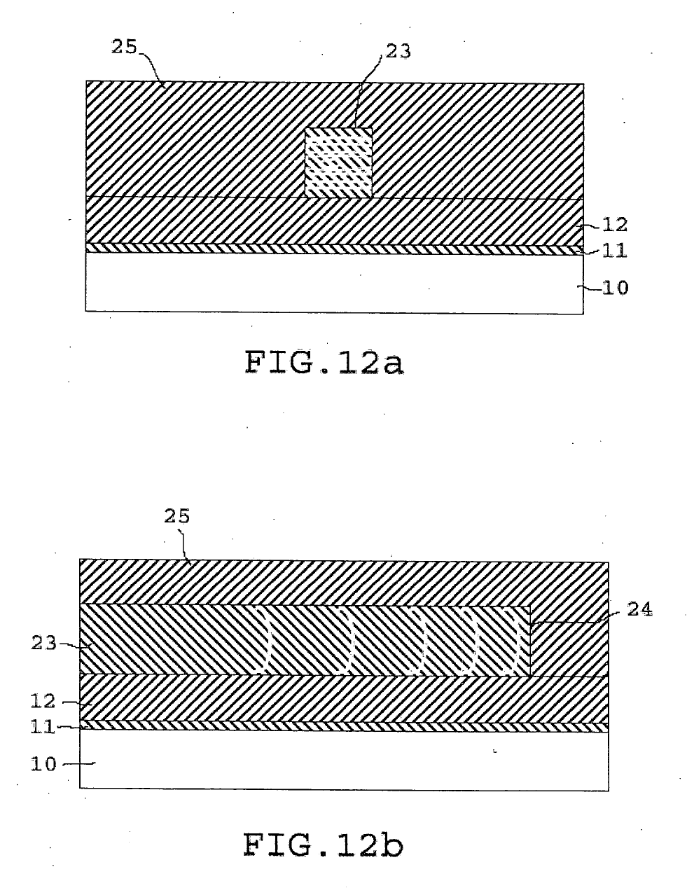

A photoresist mask 22 is then formed on the multi-layer 13 (FIGS. 9a and 9b) for definition of the waveguide cores by means of anisotropic etching of the oxide. As can be seen in FIGS. 9a and 9b, the mask 22 protects from the etching a strip of the multi-layer that lies above the region with the variable impurity density up to the point where the end of the waveguide is to be formed. At the end of the anisotropic etching (FIGS. 10a and 10b) and after removal of the mask 22 (FIGS. 11a and 11b), a protuberance 23 having a substantially square cross-section remains on the lower cladding layer 12, comprising the core of the waveguide and with a terminal segment with one end 24. Finally, a last layer of silicon dioxide 25 is deposited (FIGS. 12a and 12b), preferably having the same refractive index as the lower cladding layer 12, completely incorporating the core and forming a lateral and upper cladding.

As is clear from the above description and drawing figures, the refractive index of the terminal segment of the waveguide core gradually increases longitudinally from the value of the longest part of the waveguide, which is constant if the layers that make up the multi-layer 13 have the same refractive index as in the embodiment described, to a higher value near the end of the guide itself; therefore, the end 24 of the waveguide has an effective area greater than it would have had without the above-described treatment. It should be noted that in this embodiment the refractive index of the terminal segment also varies transversally. In particular, it decreases gradually from the center towards the lower cladding layer and towards the upper cladding layer.

In this way, a waveguide is obtained whose core has the most suitable refractive index for the transmission characteristics desired for most of its length and a higher refractive index at its input/output ends; in this way, coupling with another waveguide is more efficient.

Furthermore, the terminal segment has all the advantages of the waveguides whose refractive index gradually decreases towards the perimeter, such as good luminous energy confinement and good noise immunity.

It is understood that although only one exemplary embodiment of the invention has been illustrated and described, numerous modifications are possible without departing from the scope and spirit of the invention. For example, the multi-layer for the waveguide cores can be made up of more than three layers, each of which can be subjected to selective implantation with appropriate elements, dosages and energy in order to obtain the desired profile for the refractive index of the terminal segments of the waveguide; the material of the layers can be different from silicon dioxide provided that its refractive index can be modified through implantation; moreover, the openings of the implantation masks adjacent to the respective main openings can be more or less than three, or even totally absent: in this latter case, the gradual profile of the refractive index of the waveguide terminal segments is determined only by the reciprocal dimensions of the main areas and by the parameters of the respective implantation operations.

While there have been described above the principles of the present invention in conjunction with specific memory architectures and methods of operation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

We Claim:

1. An integrated optical waveguide comprising:
a core;
a terminal segment comprising an input/output end, wherein the core comprises a refractive index in the terminal segment that varies gradually in a longitudinal direction and increases towards the input/output end.

2. The waveguide according to claim 1, wherein the core comprises a refractive index in the terminal segment that varies gradually in a transversal direction and decreases from the center towards two opposite sides of the waveguide.

3. A process for the fabrication of an integrated optical waveguide on a substrate comprising:
deposition on the substrate of a layer of material for the lower cladding of the waveguide;
deposition on the lower cladding of a layer of material for the waveguide core;
selective removal of the material of the core to define an input/output end of the waveguide;
deposition of a layer of material for the upper cladding that covers the top and sides of the waveguide core;
wherein deposition of a layer of material for the waveguide core comprises:
successive deposition of multiple layers of a material with a pre-established refractive index;
deposition of each layer being followed by implantation of dopant impurities in a pre-established area of the respective layer in order to modify the pre-established refractive index;
high-temperature treatment to diffuse the dopant impurities; and
selecting the reciprocal position of the pre-established areas of the various layers, as well as the implantation dosages and energy, such that, after the high-temperature treatment, the refractive index of the core in a segment of the waveguide that terminates in an input/output end, varies gradually in a longitudinal direction and increases towards the input/output end of the waveguide.

4. The process according to claim 3, wherein the reciprocal position of the pre-established areas of the various layers, as well as the implantation dosages and energy, are selected such that, after the high-temperature treatment, the refractive index of the core in a segment of the waveguide that terminates in an input/output end varies gradually in a transversal direction and decreases from the center towards two opposite sides of the waveguide.

5. The process according to claim 3, wherein implantation of dopant impurities takes place also in other areas near one edge of the pre-established area.

6. An integrated optical waveguide comprising a core having a refractive index that varies gradually in a longitudinal direction and increases towards an input/output end thereof.

7. The waveguide according to claim 6, wherein the core comprises a refractive index that varies gradually in a transversal direction and decreases from the center towards two opposite sides of the waveguide.

8. The waveguide according to claim 6, wherein the core comprises three or more layers.

9. The waveguide according to claim 8, wherein at least one of said three or more layers of is subjected to selective implantation.

10. The waveguide according to claim 6, wherein the core comprises silicon dioxide.
